(19) United States
(12) Patent Application Publication
(10) Pub. No.: US 2003/0043773 A1
(43) Pub. Date: Mar. 6, 2003

(54) Multilink wireless access scheme for multiband operation in wireless mobile networks

(76) Inventor: Hyokang Chang, Potomac, MD (US)

Correspondence Address: Roberts Abokhair & Mardula, LLC, Suite 1000, 1180 Sunrise Valley Drive, Reston, VA, 20191, US

(21) Appl. No.: 10/228,982

(22) Filed: Aug. 27, 2002

Related U.S. Application Data
(60) Provisional application No. 60/316,393, filed on Aug. 31, 2001.

(51) Int. Cl. H04Q 7/24

(52) U.S. Cl. 370/338; 370/349

(57) ABSTRACT

Dynamic link switching of forward and reverse links for a wireless connection in the presence of multiple wireless networks. A mobile terminal maintains simultaneous links to multiple wireless networks, including WLANs, WPANs and proprietary networks operating over unlicensed and subscription networks. The mobile terminal generates a link profile used for dynamic reverse link selection by the mobile terminal and for dynamic forward link selection by a home node. Dynamic link selection is based on priority factors for data packets considering characteristics of all viable links.

### CROSS REFERENCE TO RELATED APPLICATIONS

This application claims priority under 35 U.S.C. §119(e) from provisional application No. 60/316,393, filed Aug. 31, 2001. The No. 60/316,393 provisional application is incorporated by reference herein, in its entirety, for all purposes.

### FIELD OF INVENTION

The present invention relates generally to link selection methods in the presence of multiple wireless networks operating over different bands for a mobile terminal. In particular, the present invention relates to dynamic link switching of forward and reverse links for a wireless connection in the presence of multiple wireless networks.

### BACKGROUND OF THE INVENTION

Broadband wired networks such as digital subscriber lines (DSLs) and cable modems are now commonplace. However, high-speed wireless networks have only recently become available. The cellular industry is addressing this issue by upgrading the cellular networks to 2.5 generation (2.5G) or 3rd generation (3G) systems that support packet data mode. Other industry groups working on short-range radios (SRRs) utilizing radio spectrums in unlicensed bands have introduced a variety of standards that will support multimedia mobile terminals in a wireless personal area network (WPAN) or wireless local area network (WLAN) environment.

These two types of networks, however, have vastly different characteristics in terms of data rates, coverage, quality of service (QoS), airtime cost, and mobility. For example, the SRRs are capable of supporting high data rates in a picocell or WLAN environment while cellular networks can provide low to medium data rates over the wide area network (WAN). While the SRRs lack the QoS support, they can provide a high-speed link at minimum airtime cost. On the other hand, while the cellular networks provide the QoS support, they can provide only a low to medium data rate at relatively high airtime cost.

Use of a cellular network to provide WLAN access is the subject of U.S. Pat. No. 5,796,727 to Harrison et al entitled “Wide-Area Wireless LAN Access” (Harrision). Harrison describes a system that allows a mobile computer to connect to a LAN via a wireless link using a cellular network. The system uses a cellular network system to affect the connection to the WLAN by the mobile terminal. The cellular network is homogeneous.

Use of SRR communication systems outside of cellular networks is the subject of U.S. Pat. No. 6,198,920 to Doviak et al entitled “Apparatus and Method for Intelligent Routing of Data between A Remote Device and a Host System” (Doviak). Doviak describes a seamless communication between a mobile device and a fixed communication network. The system is a point-to-point communication system between the host computer and a remote device, as in a 2-way paging system.

The radio infrastructure, as taught by Doviak, is part of the host network, i.e., the same communication network interface module controls the radio links. This interface provides protocol compatibility between one or more RF transceivers, public switched telephone network (PSTN) and the host network. The protocol performs dynamic selection of heterogeneous RF's for the “uplink”. The “downlink” selection is constant. Further, Doviak describes dynamic link selection (amongst several links of differing protocols) based on quality of service (QoS) criteria.

U.S. Pat. No. 5,812,951 to Ganesan et al., entitled “Wireless Personal Communication System” (Ganesan) describes a RF network comprising multiple, non-tariff bands operating outside of cellular bands. This patent describes a low powered, multi-RF transmitter system with a series of regional radio port controllers, each managing multiple radio ports. A radio port controller determines selection of a radio port, based in part on link quality as monitored by the radio port controller. Integration of all traffic control and routing is performed by a central switch.

Ganesan describes two mobile devices communicating directly via Radio Ports (RPs) rather than going through the network infrastructure when both of them are under the same Personal Communication System (PCS). When there are multiple mobile devices in the same coverage area, they can make direct connection between themselves, thus bypassing the network infrastructure.

U.S. Pat. No. 5,875,186 to Belanger et al., entitled “Dynamic Wireless Local Area Network with Interactive Communications within the Network” (Belenger), describes a wireless LAN that determines which RF transceiver access point will provide the mobile device with the best communications link. The LAN ties the access points together. An access point of the current WLAN informs the mobile device of other available access points in the neighborhood so that the mobile device can select the best link available. The mobile device selects an access point to connect to based on characteristics of each access point as communicated to the mobile device.

Dynamic selection of a RF transceiver based on reverse link QoS is the subject of U.S. Pat. No. 6,160,999 to Chheda et al entitled “Wireless Communication System Providing Improved Forward Link Management and Method of Operation” (Chheda). Chheda describes a mobile network where the mobile terminal transmits (over reverse links) to two or more base stations simultaneously. The mobile terminal transmits to the at least two base stations/sectors via a respective plurality of reverse links. Forward link transmit levels may be determined based upon the quality of corresponding reverse link transmissions or from the quality of pilot signals or forward link transmissions received by the mobile unit. Forward link transmissions are made via the most favorable forward links (at least one) while transmissions are not made, or are made at reduced power levels on the least favorable forward links. The system operates using code division multiple access protocol. Chheda is concerned with forward link selection based on the reverse link communication within a homogeneous network.

Since the characteristics of cellular and SRR networks are complementary, it is anticipated that new generation multimedia mobile terminals will support both cellular and SRR communications. A mobile terminal of this type may select a preferred network at the time of link establishment and utilize that link until another link is made. In this mode of operation, however, once the network is selected, the non-selected communications network cannot be exploited for enhancement of the QoS of the current connection or for cost savings based on airtime rates.

What would be truly useful is a system and method for spectral utilization that permits the mobile terminal to select a link based on the content of the communication and whether that communication should be routed based on lowest cost, best quality, or other criteria. The system and method for spectral utilization should provide seamless operation of service over a wide area including the use of cellular and SRR frequencies.

### BRIEF SUMMARY OF THE INVENTION

The present invention comprises a system and method that enable a mobile voice and data terminal to work with several independent or heterogeneous wireless networks by dynamically selecting the best link available for the type of communication desired.

It is an objective of the present invention to make the mobile terminal primarily responsible for link decisions in both uplink and downlink directions. In downlink direction the home node on an IP network makes a link selection based on link characteristics provided by the mobile terminal.

It is another objective of the present invention to make the home node on an IP network maintain multiple candidate care-of addresses for available wireless networks and dynamically select one that meets the selection criteria best.

It is another objective of the present invention to select wireless transmission links based on balancing link characteristics comprising data rate, coverage, mobility and quality of service (QoS) against link cost.

It is yet another objective of the present invention to provide uninterrupted coverage for wireless communication by the use of a cellular network as a background link when available.

It is still another objective of the present invention to provide improved QoS based on dynamic link management, and seamless connectivity in a mobile environment without explicit inter-system handoff.

It is a future objective to select a link based on the type of communication anticipated.

These and other objectives of the present invention will become apparent from a review of the general and detailed descriptions that follow. The present invention is embodied in a system and method that integrates the use of independent or heterogeneous wireless networks by a mobile voice and data communication system (a mobile terminal). The mobile terminal has a presence on an IP network (such as the Internet) referred to as its “home node” wherein the home node has a unique Internet Protocol (IP) address.

The wireless networks accessible to the mobile terminal access the IP network at “access points”. The home node sends and receives data packets to and from the mobile terminal via these multiple access points. Each access point has an IP address on the IP network. Further associated with each access point is a transceiver with a unique link identifier that identifies that transceiver to a particular wireless network.

The mobile terminal creates a detailed link profile for each of the wireless networks that can be accessed by the mobile terminal at a particular time. The link profile is communicated to the home node. The home node applies selection logic to link profile data provided to it by the mobile terminal to select an access point as a “destination care-of address.” The home node then forwards data packets destined for the mobile terminal to a destination care-of address access point for transmission to the mobile terminal via a transceiver associated with that access point. This access point may be the access point associated with the home node, or it may be an access point on the IP network that is associated with one of several wireless networks that can be utilized by the mobile terminal. The logic also includes information as to data packet transmission preferences so as to calculate link selection trade offs.

Similarly, the mobile terminal uses the link profile to select a link to send data to the IP Network. The mobile terminal comprises a transceiver, logic to assess the quality of all “viable” links, logic to identify “dead” links, logic to create and maintain a link profile database, and logic to dynamically select the current link for transmission destined for the home node. The mobile terminal has logic to deal with multiple, conflicting transmission protocols. When the mobile terminal's transmitted data packet is received at the access point of the chosen link, the access point transmits the data over the IP network to the home node. There is also logic to assess the data packet's transmission preferences so that the dynamic link selection is based on transmission preferences and link characteristics of all viable links.

### BRIEF DESCRIPTION OF THE DRAWINGS

FIG. 1 illustrates a multilink wireless access architecture for multiband operation topology.

FIG. 2 illustrates the decision logic of a mobile terminal of the present invention.

FIG. 3 illustrates the decision logic of a home agent of the present invention.

FIG. 4 illustrates the decision logic for link selection of the present invention.

### DETAILED DESCRIPTION OF THE INVENTION

The present invention is embodied in a system and method that integrates the use of independent or heterogeneous wireless networks by a mobile voice and data communication system (a mobile terminal). The mobile terminal has a presence on an IP network (such as the Internet) referred to as its “home node” wherein the home node has a unique Internet Protocol (IP) address.

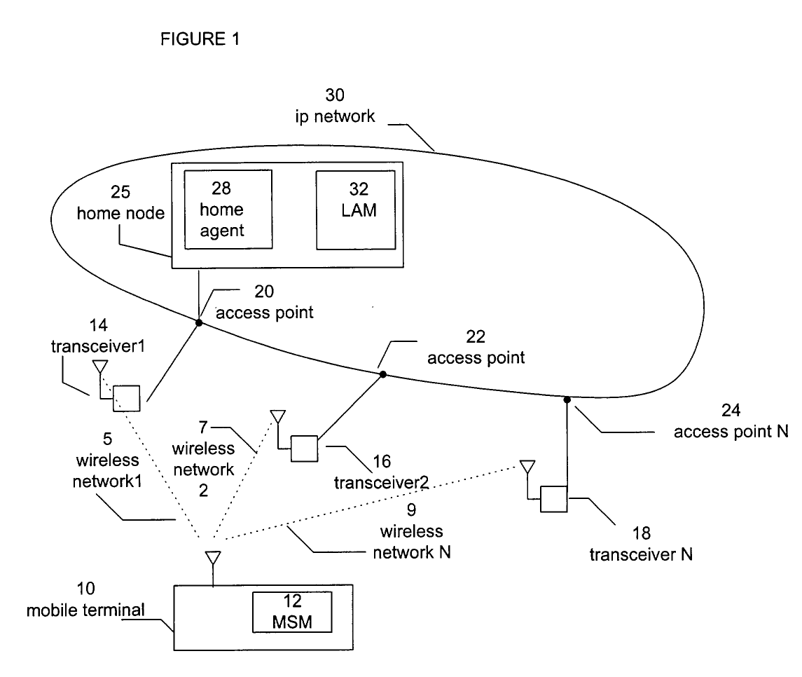

Referring to FIG. 1, a multilink wireless access architecture for multiband operation topology is illustrated. A mobile terminal 10 communicates through a plurality of wireless networks 5, 7, 9. Each wireless network establishes a link to an IP Network 30 through a transceiver 14, 16, 18 that interfaces the IP Network 30 through an access point (a particular type of node) unique to that wireless network 20, 22, 24. Each access point is identified on the IP Network 30 by an IP address. The mobile terminal is multi-network capable, meaning it is configured to operate over a plurality of networks. As will be discussed below, mobile terminal 10 further comprises a mobile support manager (MSM) 12 to manage the use of the plurality of wireless networks.

In one embodiment of the present invention, at least one of these networks operates in a licensed band comprising a cellular network meeting the standards established for 2.5G or 3G systems. The current industry standards for 2.5G and 3G cellular networks supporting packet data mode for multimedia traffic comprise CDMA 1X (IS-95C), CDMA 1X EV, GPRS, EDGE, and 3G W-CDMA. In another embodiment of the present invention, at least one of these networks operates in an unlicensed band comprising a network meeting the standards established for short-range radio (SRR) operation. In unlicensed bands the industry standards comprise Bluetooth, IEEE 802.11(a) and (b), and its variants. As would be apparent to one skilled in the art of the present invention, these embodiments are but examples of implementations of the present invention and are not intended as limitations. The scope of the present invention encompasses any type and number of independent or heterogeneous wireless networks.

IP Network 30 is configured to permit communication between devices on the IP Network. In the preferred embodiment of the present invention, this communication is implemented using devices assigned IP addresses and communicating using the TCP protocol, but this is not intended as a limitation. Any network configuration that can perform the tasks of the IP Network as disclosed herein is within the scope of the present invention. A device on the IP Network, which has been assigned an IP address, is referred to as a node. For example, each access point 20, 22, 24 is a node.

Referring again to FIG. 1, wireless network1 5 interfaces with the IP Network 30 at access point 20. The interface of wireless network1 5 with the IP Network 30 is further associated with home node 25. The home node 25 is the node assigned to the mobile terminal on the IP Network. The home node comprises home agent 28 and link assignment manager (LAM) 32. Home agent 28 and link assignment manager 32 manage communications with the mobile terminal 10 through the mobile support manager (MSM) 12. Together, the LAM 32 and MSM 12 provide the data and the logic for dynamic allocation of wireless links between the IP Network 30 and the mobile terminal 10.

MSM 12 comprises logic to identify and establish viable links using the wireless networks available to the mobile terminal, and, for each established link, logic to determine the link type, the data rate of the link, and the IP address of the access point on the IP Network associated with the wireless network that supports the established link (this IP address sometimes referred to as a care-of-address or “CoA”). The MSM 12 also measures the link quality and stores the information about the link in a link profile.

The MSM 12 monitors the availability of links and the status of existing links in real time. If a new link becomes available, the MSM 12 creates a link profile for the new link. If a previously established link is no longer viable, the link profile is updated to reflect that the previously established link is not currently available. The link profile is communicated to the home agent 28, which in turn communicates the link profile to the LAM 32.

The MSM 12 further comprises logic to dynamically select a current link on a per packet basis for transmission destined for the home node based on the link profile, and logic to deal with multiple, conflicting transmission protocols. Similarly, the LAM further comprises logic to dynamically select a current link on a per packet basis for transmission destined for the mobile terminal.

In the preferred embodiment of the present invention, the link profile comprises detailed information about each viable link. By way of example and not as a limitation, this detailed information may include the link quality in terms of estimated bit error rate, expected quality of service and data rate, the link type in terms of the protocol and frequency, and the airtime charge for a particular link. As would be apparent to one skilled in the art of the present invention, other attributes of a link can be captured in the link profile without exceeding the scope of the present invention.

The selection of a particular link for transmission of a particular packet depends on the priority assigned to the packet. In one embodiment, packets that are time and/or content critical are routed by the most reliable link. In this embodiment, control data packets are always be sent over a cellular network, regardless of cost, to ensure the reliability of the network while non-control are sent by the most economic link available.

Referring again to FIG. 1, When the mobile terminal 10 is communicating with the IP Network through an access point other than the access point associated with the home node 25, communications between the mobile terminal and the IP Network utilizes the CoA as reflected in the link profile for the link in use. As previously mentioned, the LAM 32 associated with the home node 25 and the MSM 12 associated with the mobile terminal 10 each have access to the link profile containing the most current CoA of established links.

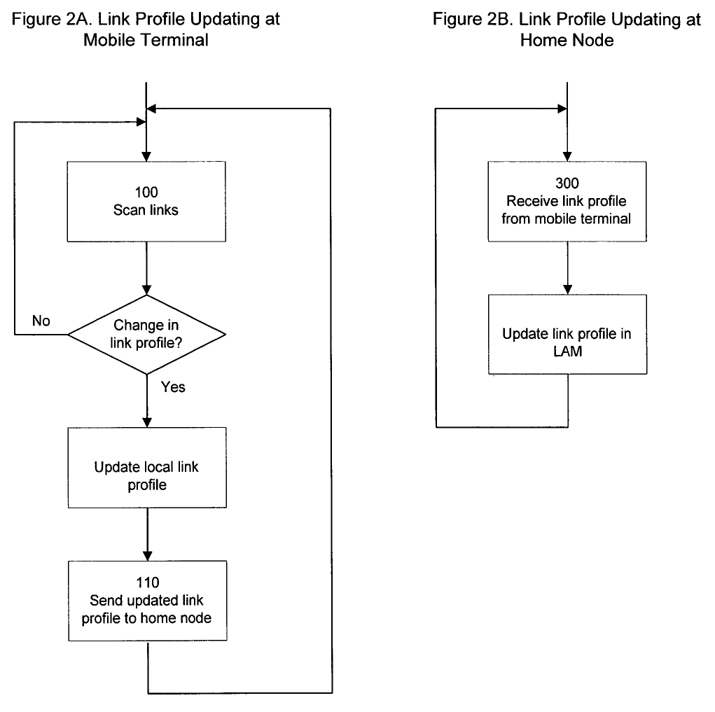

Referring to FIG. 2, the operation of the mobile terminal is illustrated. Upon session initialization, the MSM scans for all wireless links available and viable 100. Note that these links may be of various protocols and bandwidths. MSM assesses these links and creates a link profile for each link deemed viable and stores the profile 105. The profile is checked to determine if it is a new link 108 and, if so, a link profile is communicated, directly or via some access point, to the home agent at the home node 110. As conditions change for any and all links, including the addition and deletion of links, the incremental data is communicated to the home agent. The MSM selects a link for transmission of a particular packet 120 and the packet is then transmitted by the mobile terminal for reception by the wireless network chosen for the link 125.

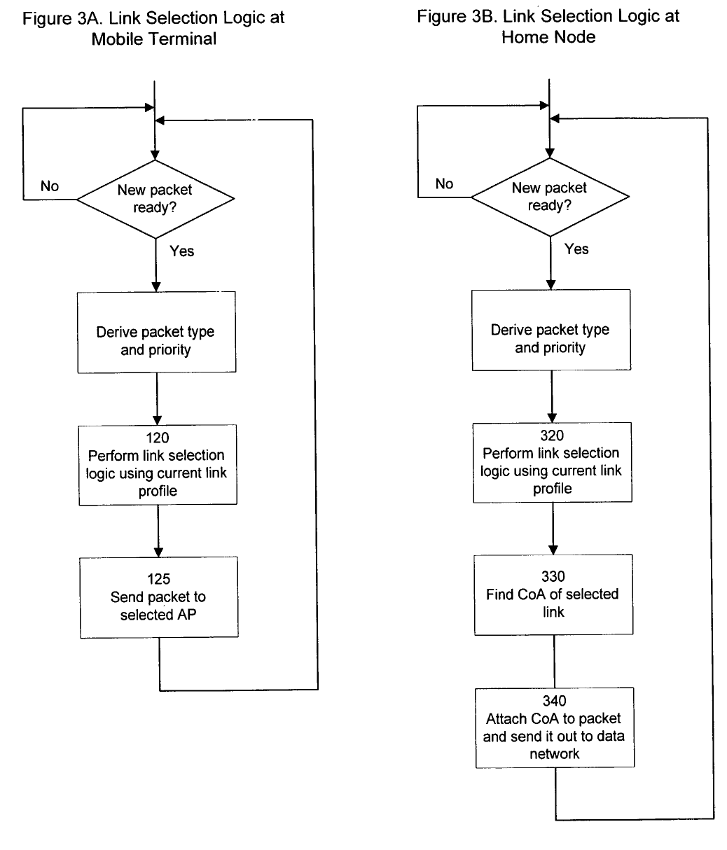

Referring now to FIG. 3, the operation of the home agent is illustrated. The link profiles that are sent by the mobile terminal are received by the home agent 300 and are sent to the LAM (link access manager) where they are stored 310. The LAM uses the link profiles to select a link for transmission to the mobile terminal 320 and communicates the CoA of the access point of the wireless network to be used for this link to the home agent 330. The home agent forwards the data packet to the CoA for transmission to the mobile terminal 340, and the packet is transmitted to the mobile terminal 350.

Since WLANs and WPANs operate over unlicensed bands on a contention basis with very little coordination, the availability and quality of a particular link constantly changes with time and are not controllable in general. By utilizing the most available link at a given time, the present invention greatly enhances the overall QoS of the wireless connection. One embodiment of the present invention, the ability to send short, but critical data packets such as control data packets over the cellular network can significantly increase the reliability of the connection.

As noted, the MSM revises the link profile when it determines that new link information is available. If a link is deleted by the MSM, data packets sent over those links by an access point may be lost. Lost data packets, however, can be recovered if necessary by sending a request for retransmission. In this way the multilink wireless access scheme can provide the seamless connectivity for the mobile terminal without requiring explicit inter-system handoffs.

As illustrated above, the present invention allows a multilink connection to be established over wireless networks based on different protocols or standards and/or the same protocol, but different bands. Three examples of multilink connections are given below.

Example 1:

(1) Link 1: Cellular network with packet data mode

(2) Link 2: 802.11(a), Band-1

(3) Link 3: Bluetooth

Example 2:

(1) Link 1: Cellular network with packet data mode

(2) Link 2: 802.11(b), Band-2

(3) Link 3: 802. 11(b), Band-1

Example 3:

(1) Link 1: 802.11(a), Band-1

(2) Link 2: 802.11(b), Band-2

(3) Link 3: Bluetooth.

The examples are presented to show that the various combinations of different link types using differing transmission protocols. The examples illustrative only and are not meant as limitations. When the home node is part of a cellular network, or otherwise has access to a cellular link, a cellular link well be in the set of usable links whenever feasible. A cellular link generally has a relatively high QoS. A cellular link may be associated with the home node or some other access point. In yet another embodiment of the present invention, there may be multiple cellular channels available to the mobile terminal.

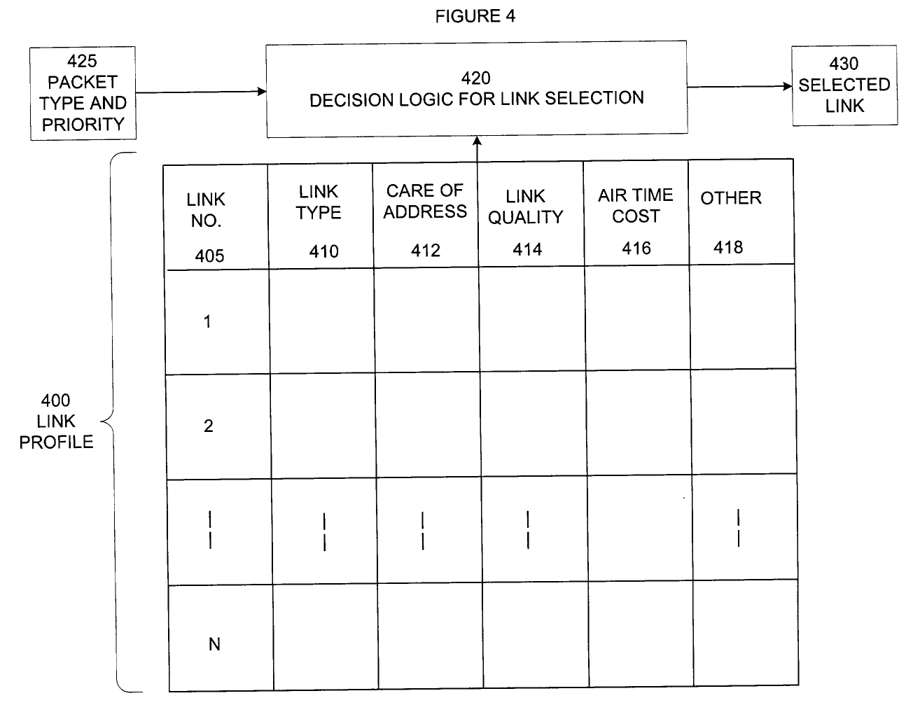

Referring to FIG. 4, decision logic for link selection is illustrated. Note that this decision logic is found in the mobile terminal and in the home node. Link profile 400 associates a link number 405 with link characteristics. As illustrated, the link profile includes link type 410, care-of address 412, and link quality 414, and airtime cost 416, but these examples are not meant as limitations. Other characteristics associated with a link include link availability, coverage, and data rate 418. In addition a characteristic may contain sub-elements. For example, the link type 410 includes the protocol or transmission standard, frequency band, and data rate associated with the particular link. The CoA 412 is the IP address of an access point on the IP network. Link quality 414 includes expected BER and transmission rate.

Decision logic 420 is applied dynamically on a per-packet basis 425 based on the type, priority and QoS target of a given data packet and the link profile. The packet type indicates whether a given data packet is a control data packet or traffic data packet and whether it is real-time sensitive or not. The decision logic weighs the packet type, priority and QoS target against the characteristics in the link profile and selects a link representing the most economic link for the particular packet to be transmitted 430.

The present invention dynamically utilizes different types of wireless networks available at a certain location by maintaining multiple wireless links between the mobile terminal and home node. The types of wireless networks that can be utilized include WLANs/WPANs operating over the unlicensed bands and 2.5G/3G cellular networks supporting packet data mode. The multiple wireless network links are based on different protocols, or the same protocol but at different radio frequencies (RF's), or any combination thereof under the direction of a mobile terminal. Further, the present invention maintains seamless connectivity for a mobile terminal without requiring explicit inter-system handoffs in a WLAN/WPAN environment utilizing a link control transmissions for link control purposes.

A multilink wireless access by those skilled in the area for multiband operation has now been illustrated. It will also be understood by those skilled in the art that the invention may be embodied in other specific forms without departing from the scope of the invention disclosed. The present examples and embodiments are in all respects illustrative and not restrictive, and the invention is not to be limited to the details given herein. Those skilled in the art of the present invention will recognize that other embodiments using the concepts described herein are also possible.

What is claimed is:

1. A method for communicating with an IP network over multiple links using multiband operation, comprising:
receiving a first data packet at a mobile terminal;
identifying from a plurality of wireless networks one or more viable communication links between the mobile terminal and the IP network;
associating a set of link metrics with each of the one or more viable communication links and saving the set of link metrics to a link profile;
selecting a first selected link from one or more viable communication links based on the link profile of the first selected link; and
sending the first data packet to the IP network over the first selected link;
sending the link profile to a home node on the IP network associated with the mobile terminal;
receiving and storing the link profile at the home node;
receiving a second data packet at the home node to send to the mobile terminal;
selecting a second selected link from the plurality of communication I inks based on the link profile of the second selected link;
sending the second data packet to the mobile terminal over the second selected link.

2. The method as in claim 1 wherein the IP network is the Internet.

3. The method as in claim 1 wherein at least one of the plurality of wireless networks operates in an unlicensed radio band.

4. The method as in claim 1 wherein at least one of the plurality of wireless networks operates in a licensed band comprising a cellular network meeting the standards established for 2.5G or 3G systems.

5. The method as in claim 4 wherein the home node is associated with the at least one of the plurality of wireless networks operating in a licensed band comprising a cellular network meeting the standards established for 2.5G or 3G systems.

6. The method as in claim 1 wherein the link metrics for a link comprise the address on the IP network of the access point associated with the link, a link type, a quality of service measure, a data transmission rate, and a time-based usage charge.

7. The method as in claim 6 wherein selecting a first selected link from one or more viable communication links based on the link profile of the first selected link comprises selecting the link with the lowest time usage charge.

8. The method as in claim 6 wherein selecting a first selected link from one or more viable communication links based on the link profile of the first selected link comprises selecting the link with the highest data transmission rate.

9. The method as in claim 6 wherein selecting a first selected link from one or more viable communication links based on the link profile of the first selected link comprises selecting the link with the best quality of service measure.

10. The method as in claim 6 wherein selecting a first selected link from one or more viable communication links based on the link profile of the first selected link comprises weighing the link metrics according to a pre-defined algorithm.

11. The method as in claim 10 wherein the first data packet comprises a priority flag and the pre-defined algorithm is selected from a plurality of pre-defined algorithms based on the priority flag of the first packet.

12. The method as in claim 6 wherein selecting a second selected link from the plurality of communication I inks based on the link profile of the second selected link comprises selecting the link with the lowest time usage charge.

13. The method as in claim 6 wherein selecting a second selected link from the plurality of communication I inks based on the link profile of the second selected link comprises selecting the link with the fastest data transmission rate.

14. The method as in claim 6 wherein selecting a second selected link from the plurality of communication I inks based on the link profile of the second selected link comprises selecting the link with the best signal quality measure.

15. The method as in claim 6 wherein selecting a second selected link from the plurality of communication I inks based on the link profile of the second selected link comprises weighing the link metrics according to a pre-defined algorithm.

16. The method as in claim 6 wherein selecting a second selected link from the plurality of communication I inks based on the link profile of the second selected link comprises weighing the link metrics according to a pre-defined algorithm.

17. The method as in claim 16 wherein the second data packet comprises a priority flag and the pre-defined algorithm is selected from a plurality of pre-defined algorithms based on the priority flag of the first packet.

18. The method as in claim 1 wherein the method further comprises:
determining that a new link is available;
determining that an established link is unavailable;
creating an updated link profile reflecting the addition of new links and the deletion of established links that are unavailable;
sending the updated link profile to the home node; and
replacing the link profile stored at the home node with the updated link profile.

19. The method as in claim 18 wherein the method further comprises resending a data packet when the data packet is sent over a link that is determined to be unavailable.

20. A mobile multilink wireless access system using multiband operation comprising:
a mobile terminal connected to a first link selector, wherein the mobile terminal comprises:
an interface for connecting to a plurality of wireless networks; and
a transceiver adapted to establish a communication link to an access point over any one of the plurality of wireless networks accessible through the interface; and
an IP network, wherein the IP network comprises:
an address associated with a plurality of access points;
a home node connected to a second link selector wherein the home node comprises a network address associated with the mobile terminal and logic to communicate with each of the plurality of access points; and
wherein, the first link selector comprises logic for:
monitoring each communication link established by the transceiver;
establishing a set of link metrics associated with a communication link and saving the set of link metrics to a link profile;
sending the link profile to the second link selector;
selecting a first link based on the link profile; and
communicating with the access point associated with the first link; and
wherein, the second link selector comprises logic for:
receiving and storing the link profile;
selecting a second link based on the link profile; and
communicating with the access point associated with the second link; and
wherein the access point comprises logic to communicate with the home node.

21. The mobile multilink wireless access system as in claim 20 wherein the IP network is the Internet.

22. The mobile multilink wireless access system as in claim 20 wherein at least one of the plurality of wireless networks operates in an unlicensed radio band.

23. The mobile multilink wireless access system as in claim 20 wherein at least one of the plurality of wireless networks operates in a licensed band comprising a cellular network meeting the standards established for 2.5G or 3G systems.

24. The mobile multilink wireless access system as in claim 23 wherein the home node is associated with the at least one of the plurality of wireless networks operating in a licensed band comprising a cellular network meeting the standards established for 2.5G or 3G systems.

25. The mobile multilink wireless access system as in claim 20 wherein the link metrics for a link comprise the address on the IP network of the access point associated with the link, a link type, a quality of service measure, a data transmission rate, and a time usage charge.
